(19) United States
(12) Patent Application Publication
(10) Pub. No.: US 2014/0333607 A1
(43) Pub. Date: Nov. 13, 2014

(54) ELECTRO-OPTICAL DEVICE AND ELECTRONIC APPARATUS FOR DISPLAYING A THREE-DIMENSIONAL IMAGE

(71) Applicant: SEIKO EPSON CORPORATION, Tokyo (JP)

(72) Inventor: Akihiko ITO, Tatsuno-machi (JP)

(21) Appl. No.: 14/339,286

(22) Filed: Jul. 23, 2014

Related U.S. Application Data
(63) Continuation of application No. 13/555,643, filed on Jul. 23, 2012.
Application No. 13/555,643 is a continuation of application No. 12/832,366, filed on Jul. 8, 2010, now abandoned.

(30) Foreign Application Priority Data
Jul. 22, 2009 (JP) 2009-170880

(51) Int. Cl. G09G 3/36; H04N 13/04

(52) U.S. Cl. CPC G09G 3/3648; G09G 3/3677; H04N 13/0434; H04N 13/0459; G09G 2310/0205; G09G 2310/0281; G09G 2320/02
USPC 345/213; 345/99

(57) ABSTRACT

An electro-optic device includes an electro-optical panel and a polarization axis conversion unit that emits transmission lights corresponding to a first image or a second image with the polarization axis of the first image intersecting the polarization axis of the second image, by converting the polarization axis of the lights emitted from the electro-optical panel. The electro-optic device further includes a scanning signal supply unit supplying scanning signals through the plurality of scanning lines and an image signal supply unit supplying a first image signal corresponding to a first image to the plurality of pixel sections during a first field period and supplying a second image signal corresponding to a second image to the plurality of pixel sections during a second field period through the plurality of data lines, the first field period and the second field period being divided into a plurality of subfield periods respectively.

This application is a Continuation of U.S. application Ser. No. 13/555,643, filed Jul. 23, 2012, which is a Continuation of U.S. application Ser. No. 12/832,366, filed on Jul. 8, 2010, which claims priority to Japanese Patent Application No. 2009-170880, filed Jul. 22, 2009. The foregoing patent applications are incorporated herein by reference.

### BACKGROUND

1. Technical Field

The present invention relates to a technical field of an electro-optical device and electronic apparatus that enable viewers to view the projected image in three dimensions.

2. Related Art

An electro-optical device which is one example of the electro-optical devices projecting the image onto a screen enables viewers to view the projected image in three dimensions by alternatively displaying separate images corresponding to viewer's right and left eyes. In the case where such a method of the electro-optical device is employed, a viewer wearing polarized glasses including of polarization plates placed on the right and left sides and having the polarization directions corresponding to respective images views the projected images while the images of two types having polarization axes that are mutually orthogonal are alternately projected. Therefore, by combining images recognized in viewer's right and left eyes respectively in the brain, a viewer can view the projected images in three dimensions.

For example, JP-A-7-270780 discloses a technique of displaying colors for three dimensional images by providing a polarization conversion element in each of three liquid crystal panels corresponding to red (R), green (G), and blue (B).

As a method to enhance the quality of the projected images, the supply rate of the scanning signal with respect to a plurality of scanning lines arranged in the image display area of an electro-optical device can be higher so as to increase the number of frames (that is, by increasing the field frequency) that can be displayed per unit time. However, such a method has its limits because the supply rate of the scanning signal relies on the performance of elements and devices included in the driving circuit of the scanning lines or the like. In addition, increase of the scanning rate results in overload in the image signal supply circuit or the like for performing input and output of image signals, due to increase of the amount of the image signal supplied to each pixel section. Furthermore, in the case of an electro-optical device capable of projecting three dimensional images, since it is necessary to display two different kinds of images corresponding to the viewer's right and left eyes, the above problems can be more serious than the case of projecting only two dimensional images because of the significant increase in the amount of the image signal.

### SUMMARY

An advantage of some aspects of the invention is providing an electro-optical device and an electronic apparatus capable of displaying three dimensional images with high color quality.

In order to achieve the above-mentioned features, an aspect of the invention provides a driving device of an electro-optical device which includes a first electro-optical panel that includes a plurality of scanning lines and a plurality of data lines arranged so as to intersect with each other in an image display area, and a plurality of pixel sections arranged corresponding to intersections between the plurality of scanning lines and the plurality of data lines; and a polarization axis conversion unit that emits transmission lights corresponding to a first image and a second image having the polarization axes intersecting with each other, by converting the polarization axes of the lights emitted from the first electro-optical panel, including a scanning signal supply unit that supplies a scanning signal through the plurality of scanning lines; and an image signal supply unit that supplies the image signal corresponding to one of either the first image or the second image to the plurality of pixel sections for each field period through the plurality of data lines, wherein the first field period in which a image signal corresponding to the first image is supplied and a second field period in which the image signal corresponding to the second image is supplied, respectively, are divided into a plurality of subfield periods in the time axis.

An electro-optical device driven by a driving device according to the aspect of the invention has a first electro-optical panel and a polarization axis conversion unit, and is able to project alternately two different types of images having the polarization axes intersecting with each other. When these two different kinds of images are, for example, the images taken by a camera having the positions corresponding to the right and left eyes or the two different kinds of images viewed by a viewer's right and left eyes, the viewer can view the images in three dimensions by wearing polarized glasses including of polarizing plates placed on the right and left sides corresponding to each image. In addition, the image displayed by the electro-optical device can be a still image or a video image. Two polarization axes intersecting with each other are typically or ideally orthogonal, but as long as it doesn't negatively affect the three dimensional image it is acceptable that the axes are not orthogonal.

The first electro-optical panel is, for example, a liquid crystal panel having a liquid crystal layer sandwiched between substrates. On operation of the first electro-optical panel by the driving device of the electro-optical device according to the aspect of the invention, for example, on inputting or outputting of various kinds of signals such as a power supply signal, data signal or control signal or the like, the scanning signal is supplied to the pixel sections through the plurality of scanning lines by the scanning signal supply unit including the scanning lines driving circuit or the like formed on the substrate. Simultaneously, for example, the image signal is supplied to the pixel sections concurrently or sequentially through the plurality of the data lines by the image signal supply unit including the data lines driving circuit or sampling circuit or the like formed on the same substrate. Thus, the first electro-optical panel emits the display light corresponding to display images from the image display area by the input and output of a variety of control signals.

The image display of the first electro-optical panel is implemented by, for example, active matrix driving carried out by a TFT for pixel switching at each pixel section arranged in the image display area in the shape of a matrix. In the above case, when the scanning signal is applied to the gate terminal of the TFT for pixel switching, the image signal supplied by the data lines is applied to the pixel electrode including of the pixel section through the source drain of the TFT for pixel switching. Consequently, the driving voltage corresponding to the image signal is applied between the pixel electrode including of the pixel section and the opposite electrode thereof so that the action condition of the electro-optic material such as the arrangement of the liquid crystal can be changed.

A first image and a second image can be displayed by converting the polarization axis of the light emitted from the first electro-optical panel to the intersecting direction at a predetermined timing by the polarization axis conversion unit included in the electro-optical device. The polarization conversion unit can, for example, be an electro-optic liquid crystal panel which has a TN (Twisted Nematic) liquid crystal sandwiched between the substrates.

The image signal supply unit supplies the image signals corresponding to one of either a first image or a second image to a plurality of pixel sections for each field period through the plurality of data lines. That is, one of either the first image or the second image is displayed in the image display area of the electro-optical device in each field period.

The first field period in which the image signal corresponding to the first image is supplied and the second field period in which the image signal corresponding to the second image is supplied, respectively, according to this embodiment, are divided into a plurality of subfield periods consecutive in the time axis. That is, each image signal corresponding to the first and second image is provided over at least two consecutive pluralities of subfield periods. Accordingly with the supply of image signals, when the first and the second images are converted to each other, the required number of the conversion operations or the like performed by the polarization axis conversion unit of the electro-optical device can be reduced. Thus, operation loads of a variety of driving circuits related to the conversion of the first and the second images to each other can be reduced, resulting in a substantial increase in the field frequency. That is, even if the displayed image is the same kind, substantially, the field frequency can be set higher due to less load on the driving circuit. Accordingly, the quality of the display image can be enhanced by increasing the number of frames capable of being displayed per unit time. In addition, by increasing the number of frames that can be displayed per unit time the image changes between the frames can be reduced so that the flicker of the display image can be reduced. In other words, the changes between respective frames can be smooth due to the increased number of frames so that the flicker can be reduced. Especially, when displaying the video image in which the display images change sequentially for each frame, the motion of the display video can be more smooth.

As disclosed above, with the driving device according to the aspect of the invention, as a result of increasing the scanning rate of the first electro-optical panel it is possible to efficiently enhance the quality of the projected image.

According to an aspect of the invention, the number of scanning lines to which the scanning signal is supplied by the scanning signal supply unit, is different for each subfield period in the plurality of subfield periods.

With such configuration, since the number of scanning lines to which the scanning signal is supplied for each subfield period does not have to be consistent, it is possible to substantially increase the field frequency, for example, by decreasing the number of scanning lines supplying the scanning signal for the predetermined subfield period. Accordingly, the creation of flicker can be efficiently suppressed in displayed images resulting in being able to display higher quality images.

According to another aspect of the driving device of the electro-optical device of the invention, the plurality of subfield periods corresponding to one of either the first field period or the second field period include of a first subfield period and a second subfield period, in which the second subfield period follows the first subfield period in a time delay, and the scanning signal supply unit supplies the scanning signal with respect to the scanning lines such that the number of the scanning lines to which the scanning signal is supplied in the second subfield period is to be one half of that in the first subfield period, and simultaneously supplies the scanning signal with respect to the plurality of scanning lines in the first subfield period.

In accordance with the above-described aspect, the plurality of subfield periods into which one of either the first field period or the second field period is divided in the time axis include a first subfield period and a second subfield period, wherein the second subfield period follows the first subfield period in a time delay. More specifically, the image signal corresponding to one of either the first image or the second image is supplied in the first subfield period and the second subfield period, in which the second subfield period appears after the first subfield period in time delay.

The scanning signal supply unit supplies the scanning signal with respect to the scanning lines such that the number of the scanning lines to which the scanning signal is supplied in the second subfield period is to be one half of that in the first subfield period. More specifically, when the electro-optical device according to the invention has total number m (m is a natural number equal to or greater than 2) scanning lines, the scanning signal supply unit supplies the scanning signal with respect to all m scanning lines for the first subfield period while supplying the scanning signal with respect to only the m/2 scanning lines for the second subfield period.

Here, the phrase “to be one half” indicates that when the number of scanning lines to be scanned for the second subfield period is a value which is not a natural number because, for example, the number of total scanning lines in the electro-optical device in accordance with the aspect of the invention is an odd number, the number of the scanning lines to be scanned can be the natural number closest to the value. For instance, if the number of scanning lines to be scanned for the first subfield period is an odd number, the number of the scanning lines to which the scanning signal is supplied for the second subfield period is computed by multiplying ½ by the value of the odd number plus 1 or minus 1.

In the second subfield period, the image is displayed by supplying the scanning signal to one half the number of scanning lines compared to in the first subfield period. The time taken to supply the scanning signal, thus, is shorter than in the first subfield period (simply, taking one half the time). With such a configuration, by limiting the number of scanning lines supplying the scanning signal in the second subfield period compared to the first subfield period, it is possible to effectively reduce the length of the subfield period in the time axis. As a result, the field frequency is increased, thereby providing high quality display images.

Furthermore, the resolution of the image displayed in the second subfield period might be lower than the image displayed in the first subfield period as a result of supplying the scanning signal with respect to only a portion (half) of the scanning lines compared to the first subfield period. However, since the pixel section of the first electro-optical panel has a retention characteristic, the image signal supplied in the first subfield period is maintained as long as a new scanning signal is not supplied until the second subfield period is over. Thus, with such a retention characteristic of the pixel section even if the image having a lower resolution is written later in the second subfield period, it is displayed as an image overwriting the image displayed in the previous subfield period (such as the first subfield period) so that the resulting resolution of the displayed image is not necessarily degraded. In other words, the image newly displayed in the second subfield period, in which the number of scanning lines to which the scanning signal is supplied is small, is displayed overwriting the previously displayed image including the image from the first subfield period so that, as a result, it is possible to display a high resolution image. That is, even though the resolution itself of the image newly written in the second subfield period is low, it is possible to display the high resolution of the image by overwriting the image displayed in advance in the previous subfield period such as the first subfield period.

Also, the scanning signal supply unit simultaneously supplies the scanning signal with respect to the plurality of scanning lines in the first subfield period. More specifically, since the time needed to supply the scanning signal in the first subfield period (such as the length of the first subfield period) can be shorter by supplying simultaneously the scanning signal with respect to the plurality of the scanning lines, it is possible to substantially increase the field frequency.

On the other hand, the resolution of the displayed image degrades because of the same image signal being supplied to the plurality of the pixel sections which is in turn caused by the scanning signal being simultaneously supplied to the plurality of scanning lines. However, it is not a major problem, for the merits obtained from increasing the field frequency offset the lowering of the image resolution. Furthermore, as discussed above, with a retention characteristic of the pixel section of the first electro-optical panel, the resulting resolution of the image displayed is high as the image having the low resolution is overwritten in sequence.

As disclosed above, in the driving device of the electro-optical device in accordance with the aspect of the invention, it is possible to display a high quality three dimensional image by implementing both an increased field frequency and a high resolution of the image displayed.

According to another aspect of the driving device of the elector-optical device of the invention, a third field period in which an image signal corresponding to black color display is supplied by the image signal supply unit, is provided between the consecutively repeated first and second field periods.

As disclosed above, the polarization axis conversion unit converts the polarization axes of the image for the left eye and the image for the right eye to be intersecting so that a viewer wearing polarized glasses can view the images in the right and left eyes separately. Here, for example, in the case that the polarization axis conversion unit is in the form of an electro-optical panel having an electro-optical material such as a liquid crystal sandwiched between the substrates, the conversion of the polarization axis is performed by scanning the scanning lines in sequence to the transmission area through which the display light is transmitting resulting in it having a finite time to finish scanning of the transmission area. With this implementation, while the polarization axis conversion unit is performing the conversion (for example, on scanning the scanning lines in sequence in the transmission area), a portion of the transmission area might be polarized for the right eye and the other portion polarized for the left eye. Thus, in this arrangement, if the light emitted from the polarization axis adjustment unit enters the polarization axis conversion unit, it causes mixing of the images to be displayed for the right and the left eyes, resulting in lowering of the quality of the projected image, causing difficulty for a viewer to view the image in three dimensions, in serious cases.

In the driving device according to the aspect of the invention, a third field period is provided between the first field period and the second field period to display black color when changing the first field period displaying the first image and the second field period displaying the second image to each other. Therefore, lowering of the image quality due to mixing of the right and left images as described above can be effectively prevented by providing the third field period. That is, by displaying the black color in the plurality of the first electro-optical panels in the third field period including the period in the middle of the conversion operation done by the polarization axis conversion unit in which there might be mixing of the right and left images as disclosed above, even though mixing of the right and left images occurs, a viewer cannot recognize the reduction in image quality. In other words, by displaying the black color as a conversion timing of the right and left images, it is possible to accurately distinguish the images for the right and left eyes from each other. Therefore, it allows the driving device of the electro-optical device to display high quality three dimensional images.

According to still another aspect of the driving device of the electro-optical device of the invention, the scanning signal supply unit supplies the scanning signal such that the update timing of the display image in the first electro-optical panel and the conversion timing of the polarization axes of the display lights, which is converted by the polarization axis conversion unit, are synchronized.

With this aspect, the polarization axis conversion unit included in the electro-optical device driven by the driving device is, for example, an electro-optical panel such as a liquid crystal panel having TN liquid crystal sandwiched between the substrates. In this case, similar to the first liquid crystal panel, for example, it is formed by sandwiching the electro-optic material, such as a liquid crystal, between an element substrate on which a transistor for the pixel-switching, the data lines, the scanning line and a pixel electrode are formed, and a counter substrate on which a counter electrode is formed. In this case, in order not to mix the first image and the second image, by controlling synchronization between the second electro-optical panel, acting as the polarization axis conversion unit, and the first electro-optical panel, with proper timing, it is possible to display a high quality three dimensional image. This synchronization control can be facilitated using a common clock signal and a common trigger signal in the first and second electro-optical panels, for example.

To solve the above-mentioned problems, the electro-optical device of the invention includes the driving device of the electro-optical device in accordance with the invention as mentioned above (including all aspects of the invention).

According to the electro-optical device of the aspect of the invention, by having the driving device related to the invention it is possible to increase the field frequency resulting in high quality of the displayed three dimensional images.

To overcome the above problem, the electronic apparatus of the aspect of the invention includes the above-mentioned electro-optical device (including all aspects of the invention).

According to the electronic apparatus, a variety of electronic apparatuses such as a projection type liquid crystal projector capable of displaying high quality three dimensional images can be implemented having the electro-optical device.

To solve the above-mentioned problems, a driving method of the electro-optical device according to the aspect of the invention includes a first electro-optical panel that includes a plurality of scanning lines and a plurality of data lines arranged so as to intersect with each other in an image display area, and a plurality of pixel sections arranged corresponding to intersections between the plurality of scanning lines and the plurality of data lines, and a polarization axis conversion unit that emits transmission lights corresponding to a first image and a second image having the polarization axes intersecting with each other, due to conversion of the polarization axes of the lights emitted from the first electro-optical panel, including a supplying scanning signal that is supplied through the plurality of scanning lines; and supplying the image signal corresponding to one of either the first image or the second image to the plurality of pixel sections for each field period through the plurality of data lines, wherein the first field period in which the image signal corresponding to the first image is supplied and the second field period in which the image signal corresponding to the second image is supplied, respectively, are divided into a plurality of subfield periods in the time axis.

In accordance with the above-described driving method, similar to the driving device according to the aspect of the invention, it is possible to increase substantially the field frequency resulting in being capable of displaying a high quality three dimensional image.

Also, in the driving method of the aspect of the invention, all the same aspects pertaining to the above-mentioned driving device of the aspect of the invention can be employed.

These features and other advantages of the aspect of the invention will be disclosed in the following implementations hereafter.

### BRIEF DESCRIPTION OF THE DRAWINGS

The aspects of the invention will be described with reference to the accompanying drawings, wherein like numbers reference like elements.

FIG. 1 is a sectional view showing schematically the overall configuration of a liquid crystal projector related to the embodiment.

FIGS. 2A and 2B are conceptual views showing schematically the polarization axis of the lights emitted from a cross prism in each stage of the transmission process of the polarization axis converter of the liquid crystal projector according to the embodiment.

FIG. 3 is a schematic view showing the usage of polarized glasses for a viewer to view the image projected by the liquid crystal projector according to the embodiment.

FIG. 4 is a plan view showing the structure of the liquid crystal panel enclosed by the liquid crystal light valve of the liquid crystal projector according to the embodiment.

FIG. 5 is an V-V sectional view of FIG. 4.

FIG. 6 is a block diagram showing a simplified structure of the liquid crystal panel enclosed by the liquid crystal light valves of the liquid crystal projector according to the embodiment.

FIGS. 7A and 7B are perspective views showing the three dimensional structure in the transmission area of the polarization axis conversion panel of the liquid crystal projector according to the embodiment.

FIG. 8 is a block diagram showing a simplified structure of the polarization axis conversion panel of the liquid crystal projector according to the embodiment.

FIG. 9 is a timing chart of the respective control signals inputted/outputted to/from the liquid crystal panel and the polarization axis conversion panel with respect to the operations of the liquid crystal projector according to the embodiment.

FIG. 10 is a timing chart of the respective control signals inputted/outputted to/from the liquid crystal panel and the polarization axis conversion panel with respect to the operations of the liquid crystal projector according to the modified examples.

### DESCRIPTION OF EXEMPLARY EMBODIMENTS

Hereinafter, an electro-optical device according to an embodiment of the invention will be described with reference to the drawings. In particular, the following description will describe a projection type liquid crystal projector as an example, which is the electronic apparatus employing an electro-optical device according to the invention.

### Structure of Liquid Crystal Projector

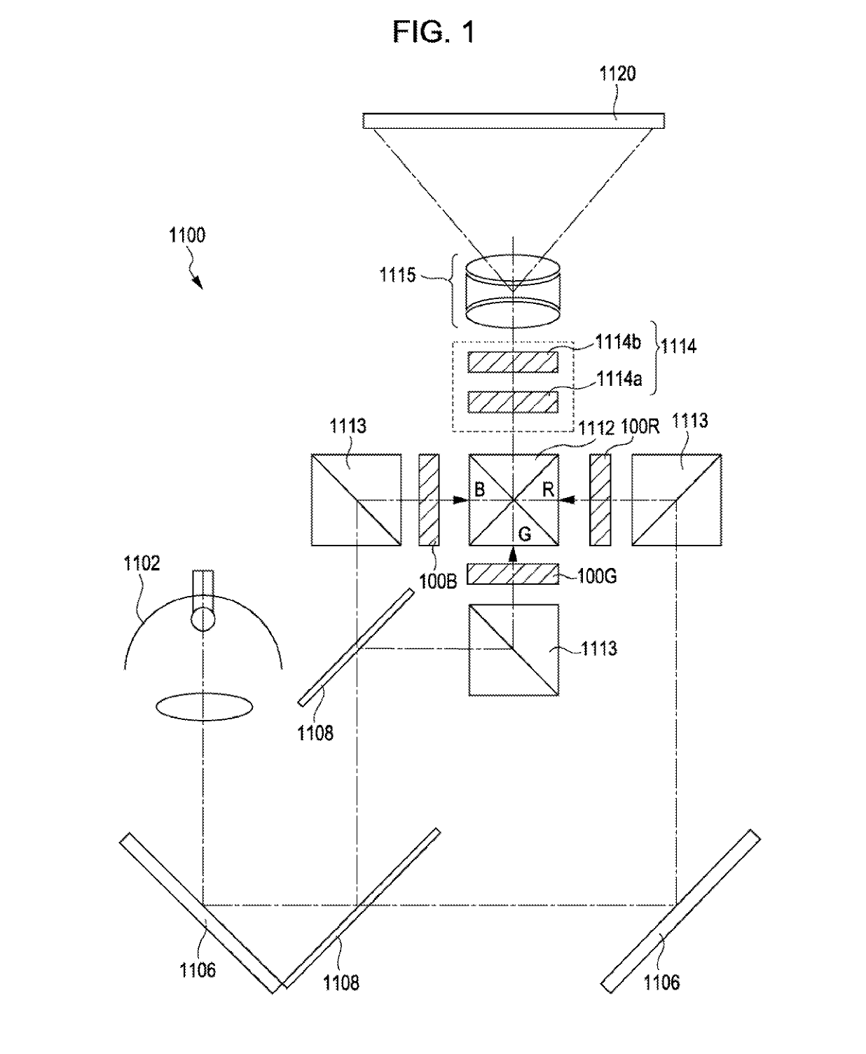

First, referring to FIG. 1, the overall structure of the liquid crystal projector according to the embodiment is described. FIG. 1 is a sectional view showing schematically the overall structure of the liquid crystal projector related to the embodiment.

In FIG. 1, a liquid crystal projector 1100 according to the embodiment is configured as a multi-substrates type of color projector using the three liquid crystal light valves 100R, 100G and 100B for RGB. The respective liquid crystal light valves 100R, 100G and 100B are enclosed in the predetermined holding case for fixing the liquid crystal panel 1 to the outer wall of the liquid crystal projector 1100. Also, the liquid crystal panel 1 is one example of the first electro-optical panel according to the embodiment of the invention.

As shown in FIG. 1, in the liquid crystal projector 1100, when the light source lights are emitted from the lamp unit 1102 of the white light source, such as a metal halide lamp, the light source lights are divided into the optical components R, G and B corresponding to the three primary colors of RGB by a pair of mirrors 1106, a pair of dichroic mirrors 1108 and the three polarizing beam splitters (PBS) 1113. The respective optical components are conducted to the corresponding liquid crystal light valves 100R, 100G and 100B. Furthermore, it could be provided with, preferably, a lens in the middle of an optical path to prevent beam loss in the optical path. Additionally, the optical components corresponding to the three primary colors, respectively, and modulated by the liquid crystal light valves 100R, 100G and 100B are combined into a single flux of light by the cross prism 1112, and then enter the polarization axis converter 1114.

The polarization axis converter 1114 is configured by a color select panel 1114a as an example of the polarization axis adjustment unit of the embodiment of the invention, and a polarization axis conversion panel 1114b as the polarization axis conversion unit of the embodiment of the invention. The emitted lights transmitted from the polarization axis converter 1114 are transmitted through the projection lens 1115, and then are projected in an enlarged color video onto a screen 1120.

According to the embodiment of the invention, the liquid crystal light valves 100R, 100G and 100B are provided with the incident of the optical components corresponding to the three primary colors of RGB respectively by the dichroic mirror 1108 and the polarizing beam splitters 1113, thereby there is no need to have a color filter in each of the liquid crystal light valves 100R, 100G and 100B for RGB. In contrast, in the case that the polarizing beam splitters 1113 are not used, it is preferable to have a color filter in each of the liquid crystal light valves 100R, 100G and 100B for RGB.

The liquid crystal projector 1100 projects alternately the image for the right eye and the image for the left eye at a predetermined timing onto the screen 1120, thereby, a viewer wearing the polarized glasses can view the projected image in three dimensions. Additionally, the conversion timing of the image for the right eye and the image for the left eye, and the features of the polarized glasses which the viewer wears will be described, in detail below.

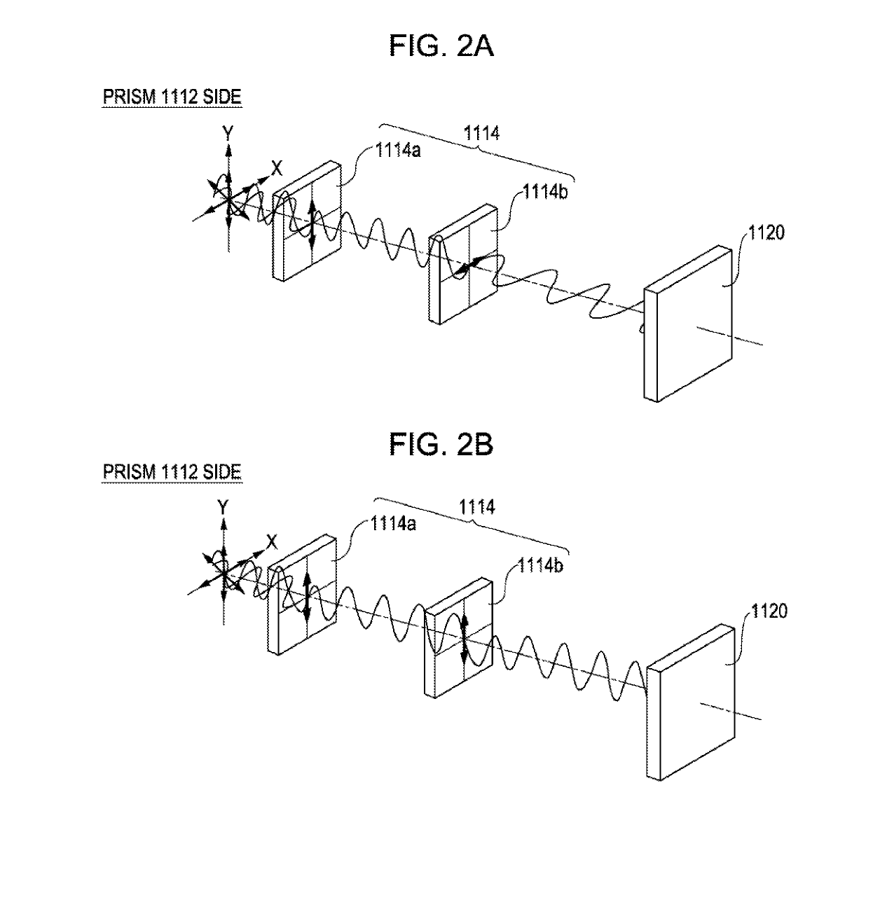

Referring to FIGS. 2A and 2B, in each stage of the transmission process of the polarization axis converter 1114, the polarization axes of the lights emitted from the cross prism 1112 will be described in detail. FIGS. 2A and 2B are conceptual views showing the polarization axes of the lights emitted from the cross prism 1112 in each stage of the transmission process of the polarization converter 1114.

The lights emitted from the cross prism 1112 are the combined lights of the optical components from the plurality of the liquid crystal light valves 100R, 100G and 100B. In this embodiment, among the liquid crystal light valves 100R, 100G and 100B, the optical components from the liquid crystal light valves 100R and 100B have the polarization axes in the same direction (X direction), and, on the other hand, the optical component from the liquid crystal light valve 100G has a polarization axis (Y direction), which is perpendicular to them. Thus, the lights emitted from the cross prism 1112 which are the combined optical components for RGB have the polarization axes in the X and Y directions.

In this embodiment, the lights from the cross prism 1112 having polarization axes in multiple directions can be adjusted to have one direction by transmitting those lights to the color select panel 1114a included in the polarization axis converter 1114 as a part. This aligning of the polarization axes can be implemented by embodying a device, as the color select panel 1114a, having the feature of changing the polarization axis direction by a defined angle with respect to the optical components corresponding to specific colors. One example device of the color select panel 1114a, for instance, can be A WAVELENGTH-SELECTABLE POLARIZATION ROTATOR•COLOR SELECT (registered trade mark) manufactured by ColorLink, Inc. This product has such a feature of changing the polarization axis of the optical component having a certain wavelength by a predetermined angle, so that it meets the function of the color select panel 1114a.

In this embodiment, the optical component from the liquid crystal light valve 100G has a polarization axis in the Y direction which is perpendicular to the polarization axis in an X direction of the optical components from the liquid crystal light valves 100R and 100B. Thus, the color select panel 1114a is employed as a device having such a feature of rotating the polarization axis by 90 degrees with respect to the lights having a wavelength corresponding to the optical components from the liquid crystal light valve 100G. As a result, the lights having multiple polarization axes from the cross prism 1112 can be aligned by transmitting them to the color select panel 1114a. In the JP-A-7-270780, each of the liquid crystal panels 100 corresponding to RGB respectively requires a polarization conversion element to align the polarization axes, however, in this embodiment, it is possible to align the polarization axes with only one color select panel 1114a. Consequently, it allows reducing the number of parts for configuring the liquid crystal projector 1100 resulting in reduction of the manufacturing cost.

The lights emitted from the color select panel 1114a enter a polarization axis conversion panel 1114b which, together with the color select panel 1114a, configures partly the polarization axis converter 1114. The polarization axis conversion panel 1114b converts alternatively the polarization axes of the emitted lights from the color select panel 1114a to have an intersecting direction (X direction or Y direction) at a predetermined timing. Here, FIGS. 2A and 2B are conceptual diagrams showing the polarization axes of the display lights corresponding to the image for the right eye and the image for the left eye respectively. The polarization axis in the Y direction of the lights emitted from the color select panel 1114a is converted to the polarization axis in the X direction by transmitting the lights to the polarization axis conversion panel 1114b at a certain timing (referring to FIG. 2A). In another timing, the polarization axis is maintained in the Y direction (referring to FIG. 2B). In this way, the polarization axis conversion panel 1114b can be controlled so as to form the display lights corresponding to the image for the right eye and the image for the left eye respectively having the polarization axes in intersecting directions from each other.

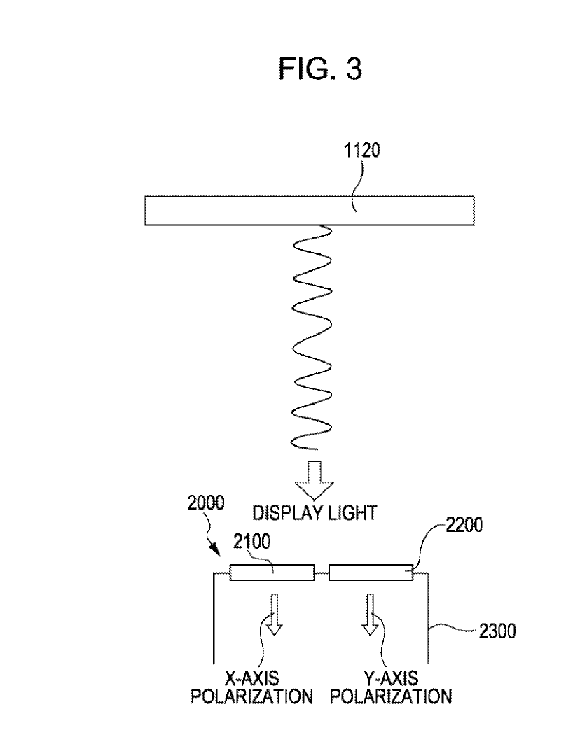

Next, described are the polarized glasses capable of being worn by a viewer when the viewer views the video projected onto a screen 1120 by the above-mentioned liquid crystal projector 1100. Here, FIG. 3 illustrates the usage of polarized glasses by a viewer when viewing the image projected by the liquid crystal projector 1100 in accordance with the embodiment. The viewer uses the polarized glasses 2000 shown in FIG. 3 to view the image projected onto the screen 1120, thereby viewing the projected image in three dimensions.

The polarized glasses 2000 are configured with a lens 2200 for the right eye and a lens 2100 for the left eye, which are fixed to a frame 2300. The lens 2100 for the left eye is formed with a polarizer having the same polarization direction (X direction) as the polarization axis of the image for the left eye. On the other hand, the lens 2200 for the right eye is formed with a polarizer having the same polarization direction (Y direction) as the polarization axis of the image for the right eye. Thus, the display light corresponding to the image for the left eye can be transmitted through the lens 2100 for the left eye having the same polarization axis direction, but cannot be transmitted through the lens 2200 for the right eye having a different polarization axis direction. In contrast, the display light corresponding to the image for the right eye can be transmitted through the lens 2200 for the right eye having the same polarization axis direction, but cannot be transmitted through the lens 2100 for the left eye having a different polarization axis direction.

Accordingly, the lights transmitted through the lens 2100 for the left eye and the lens 2200 for the right eye, respectively, enter the right eye or the left eye of the viewer by travelling through the polarized glasses 2000. As a result, the viewer wearing the polarized glasses 2000 can view separately the image for the left eye and the image for the right eye with the left eye and the right eye, so that it is possible to view the image projected onto the screen 1120 in the three dimensions.

### Configuration of Liquid Crystal Panel

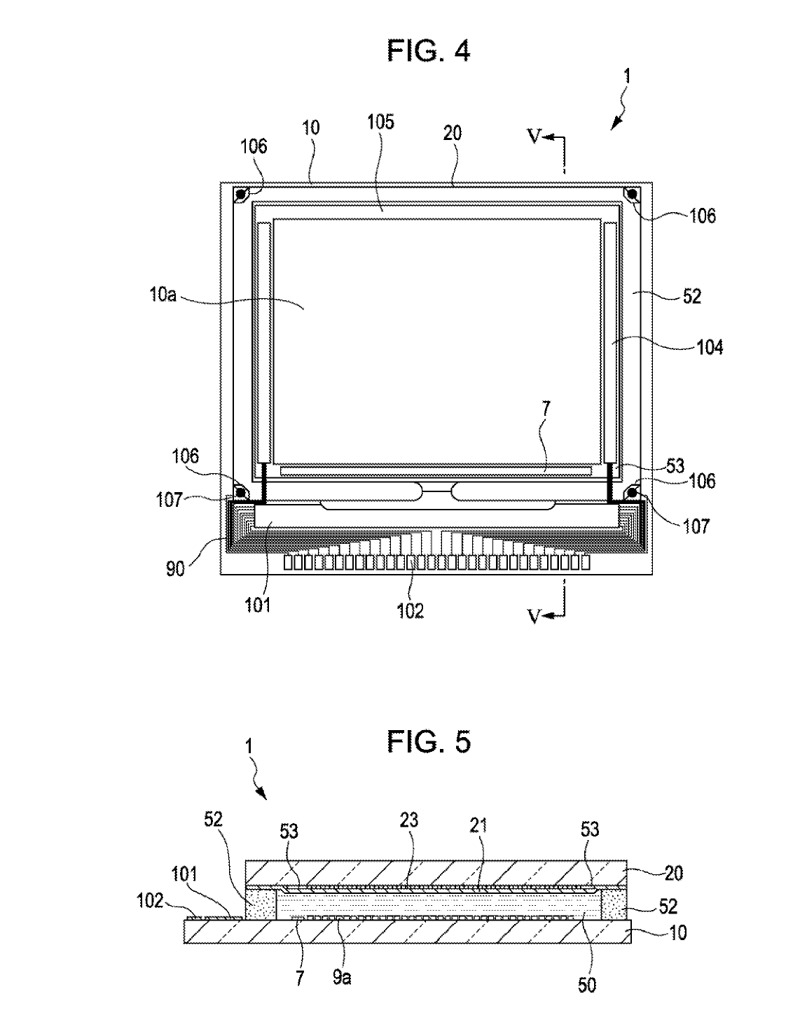

Next, referring to FIG. 4 and FIG. 5, the configuration of the liquid crystal panel 1 enclosed by the liquid crystal light valves 100R, 100G and 100B is disclosed. FIG. 4 is a plan view showing the liquid crystal panel 1 enclosed by the liquid crystal light valve 100 according to the embodiment, and FIG. 5 is an V-V cross sectional view of FIG. 4.

As shown FIG. 4 and FIG. 5, in the liquid crystal panel 1, a TFT array substrate 10 is arranged to face a counter substrate 20. A liquid crystal layer 50 is sealed between the TFT array substrate 10 and the counter substrate 20, and the TFT-array substrate 10 and the counter substrate 20 are bonded together with a sealing material 52 around an image display area 10a.

In FIG. 4, a frame light-shielding film 53 for shielding the lights is provided in parallel with the inside of the sealing material 52 on the side of the counter substrate 20. Of the peripheral area of the image display area 10a, an area outside the sealing material 52 has a data-line driving circuit 101 and external-circuit connecting terminals 102 along one side of the TFT-array substrate 10. A sampling circuit 7 is disposed more inner side than the sealing material 52 along the side of the TFT-array substrate 10 in such a manner as to be covered with the frame light-shielding film 53. Additionally, scanning-line driving circuits 104 are disposed inner side of the sealing material 52 along the two sides next to the one side in such a manner as to be covered with the frame light-shielding film 53. Furthermore, a plurality of wires 105 are provided to connect the two scanning-line driving circuits 104 provided on both sides of the image display area 10a in such a manner as to extend along the remaining one side of the TFT-array substrate 10 and to be covered with the frame light-shielding film 53. The TFT-array substrate 10 has thereon vertically conducting terminals 106 for connecting both substrates with vertically conductive materials 107 at the positions opposing the four corners of the counter substrate 20. This allows electrical conduction between the TFT-array substrate 10 and the counter substrate 20.

On the TFT array substrate 10, guiding wires 90 are provided for electrically connecting external-circuit connecting terminals 102, a data-line driving circuit 101, scanning-line driving circuits 104, and vertically conductive materials 106 or the like.

Referring FIG. 5, the image display area 10a of the TFT-array substrate 10 has thereon a layered structure in which TFTs for switching pixels and wires, such as scanning lines and data lines, are formed. In addition, around the image display area 10a, a layered structure is provided in which TFT for driving circuits such as a data-line driving circuit 101, scanning-line driving circuits 104 and a sampling circuit 7, and guiding wires 90 are formed.

Although not shown in the Figures, an alignment film is provided on the pixel electrodes 9a of the TFT-array substrate 10. On the other hand, black matrices 23 made of a light-shielding material are formed on the counter substrate 20 on the opposing surface of the TFT array substrate 10. Black matrices 23 have thereon the counter electrode 21 made of a transparent material, such as ITO, in such a manner so as to oppose the plurality of pixel electrodes 9a. An alignment film (not shown) is formed on the counter electrode 21. The liquid crystal layer 50 according to this embodiment, for example, includes of a liquid crystal that is made of mixing one or several kinds of nematic liquid crystal, which is aligned in a predetermined orientation between a pair of alignment films.

Although not shown, an inspection circuit and inspection pattern for checking the quality of the electro-optical device for defects during manufacture and at shipment and so on, in addition to the driving circuits such as the data-line driving circuit 101 and the scanning-line driving circuits 104 are formed on the TFT array substrate 10.

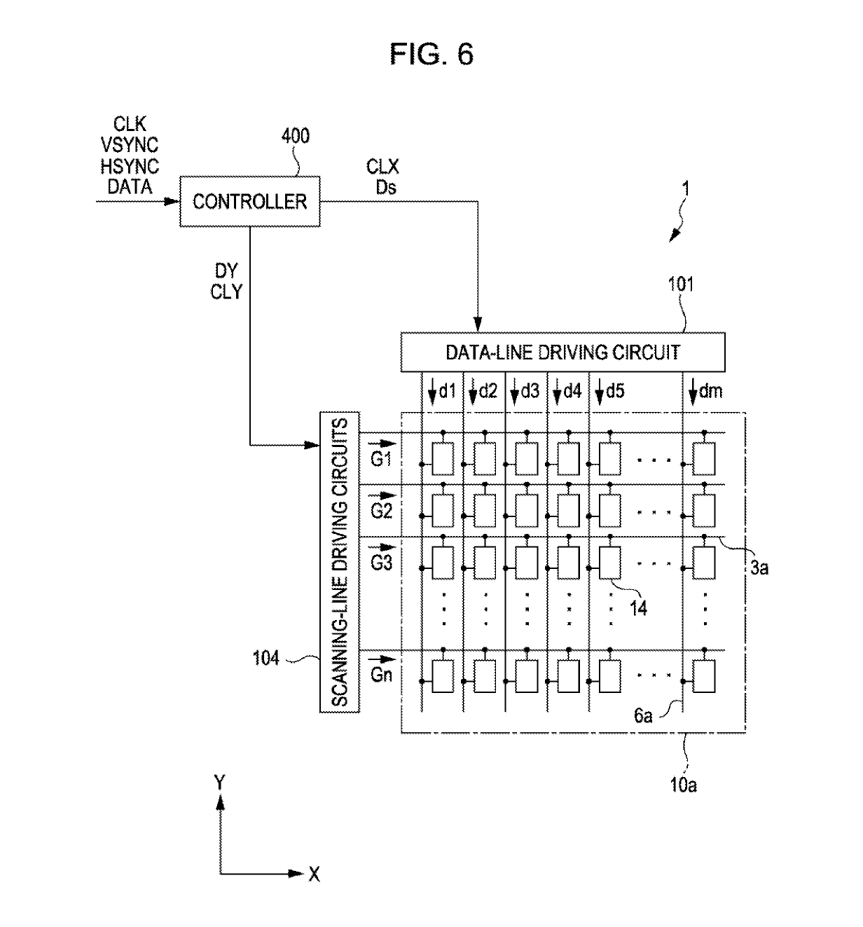

Next, referring to FIG. 6, an electrical configuration of the liquid crystal panel 1 enclosed by the liquid crystal light valves 100R, 100G and 100B is disclosed. FIG. 6 is a block diagram showing a simplified configuration of the liquid crystal panel 1 enclosed by the liquid crystal light valves 100R, 100G and 100B.

The liquid crystal panel 1 includes an image display area 10a, data-line driving circuit 101 and scanning-line driving circuits 104. In the image display area 10a from which the display light is emitted, the image is displayed by on/off controlling the driving voltage applied to the liquid crystal layer 50. In the image display area 10a, n (n is a natural number equal to or greater than 2) scanning-lines 3a in a X (row) direction and m (m is a natural number equal to or greater than 2) data-lines 6a in a Y (column) direction are formed successively. Furthermore, a matrix-form pixel section 14 is arranged at each intersection of scanning-lines 3a and data-lines 6a.

A controller 400 obtains a clock signal (CLK), a vertical scanning signal (VSYNC), a horizontal scanning signal (HSYNC) and an image signal (DATA) externally. Then, the controller 400 generates a scanning-side start pulse (DY), a scanning-side transmission clock (CLY), a data transmission clock (CLX) and an image data signal (Ds) based on the externally obtained signal. The scanning-side start pulse (DY) is a output pulse signal outputted as an initial timing of the scanning in the scanning-side (Y side). The scanning-side transmission clock (CLY) is a clock signal defining scanning timing in the scanning-side (Y side). The data transmission clock (CLX) is a signal defining a transmission timing of the data to a data-line driving circuit 101. The image data signal (Ds) is a voltage signal corresponding to the image signal (DATA).

The scanning-line driving circuits 104 output sequentially the scanning signals (G1, G2, G3, . . . Gn) to the scanning-lines 3a in the image display area 10a by obtaining the scanning-side start pulse (DY) and the scanning-side transmission clock (CLY) from the controller 400. The scanning-line driving circuits 104 which, for example, are configured by a shift register, drive the scanning-lines 3a in sequence, specifically, in a line sequence method, based on the scanning-side start pulse (DY) according to the scanning-side transmission clock (CLY) provided from the controller 400. However, although in this embodiment a line sequence method is employed to drive the scanning-lines 3a, different kinds of methods are possible to drive the scanning-lines.

The data-line driving circuit 101 outputs the data signal (d1, d2, d3, . . . dm) with respect to the data-lines 6a in the image display area 10a by obtaining the data transmission clock (CLX) and the image data signal (Ds) from the controller 400. More specifically, the data-line driving circuit 101 m-sequence latches the image data signal (Ds), m corresponding to the number of the data lines 6a, in a certain period of horizontal scanning, and then supplies the latched m image data signal (Ds) to the one-to-one corresponding data-lines 6a as a data signal (d1, d2, d3, . . . dm) in the next horizontal scanning period.

### Configuration of Polarization Axis Conversion Panel

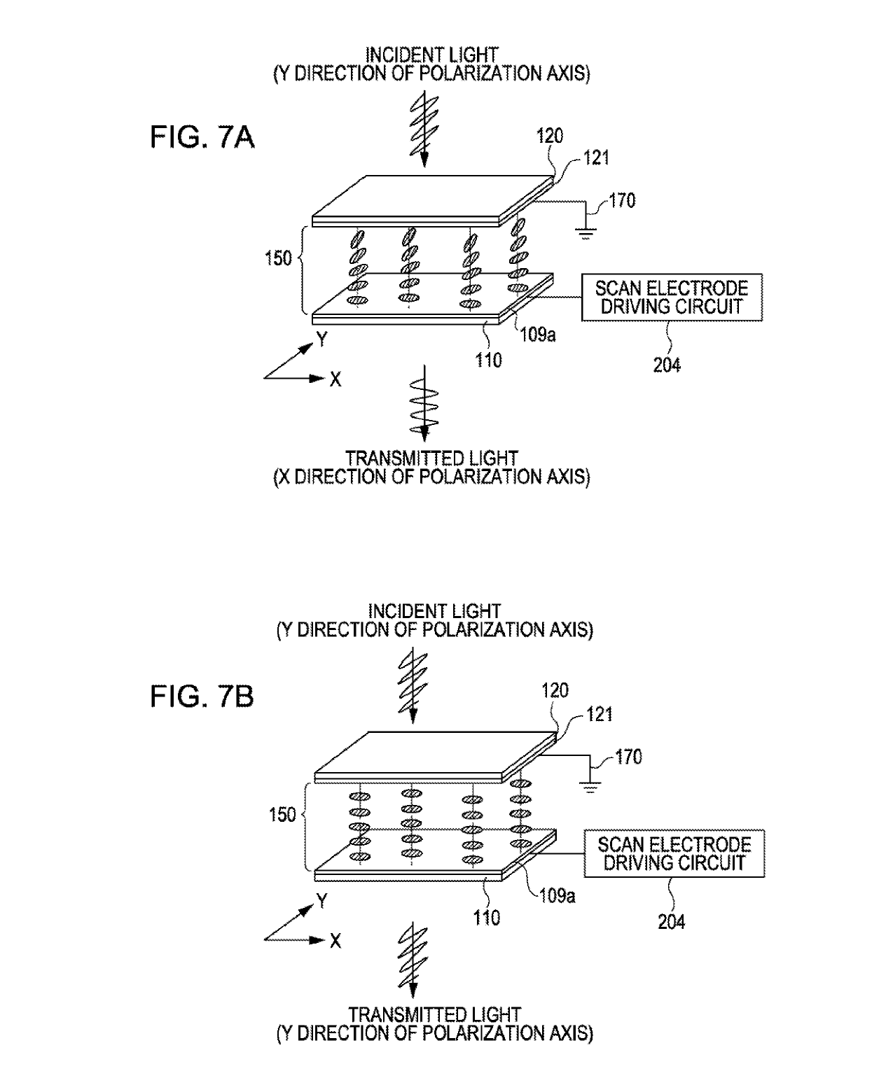

Referring to FIG. 7, a configuration of a polarization axis conversion panel 1114b according to the embodiment is disclosed. FIG. 7 is a perspective view showing a configuration of the transmission area 110a of the polarization axis conversion panel 1114b according to the embodiment. In this embodiment, the transmission area 110a is an area through which the lights emitted from the color select panel 1114a are permeable.

The polarization axis conversion panel 1114b has the same structure as the liquid crystal panel 1, which includes a liquid crystal layer sandwiched between a pair of substrates. That is, the polarization axis conversion panel 1114b is a type of liquid crystal panel. Here, is described the main differences in the structures of the polarization axis conversion panel 1114b, and the liquid crystal panel 1.

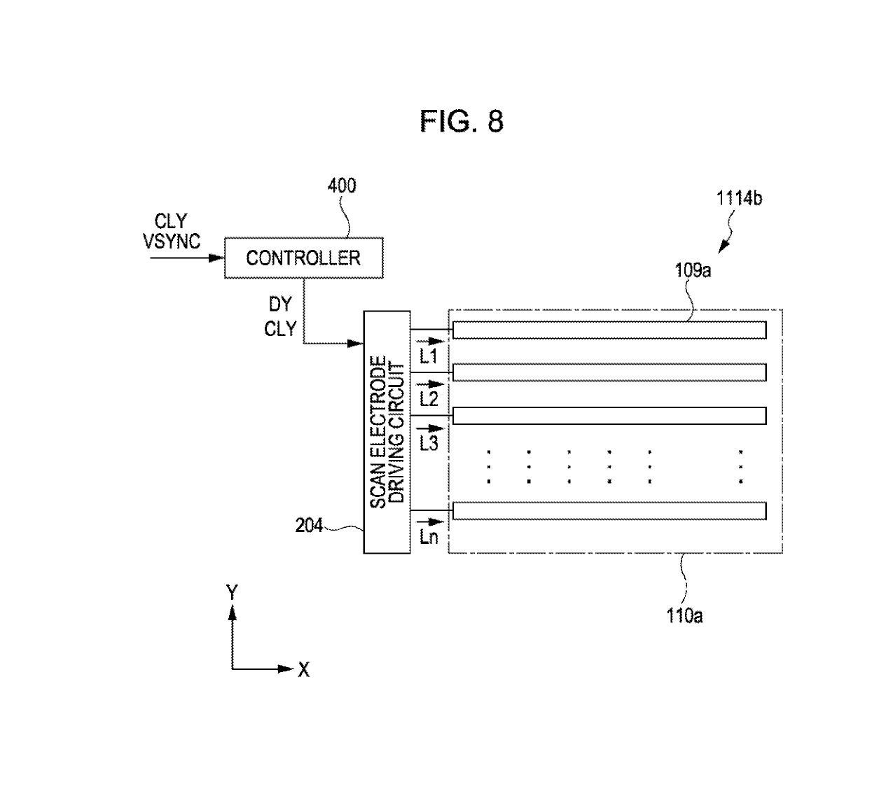

In the transmission area 110a of the polarization axis conversion panel 1114b, a scan electrode 109a and a counter electrode 121 are formed on the component substrate 110 and a counter substrate 120, respectively. In the scan electrode 109a, a voltage potential is controlled in such a manner that a scan electrode driving circuit 204 is electrically connected. FIG. 7 does not show the scan electrode 109a in detail for simplicity of explanation, but actually, the scan electrode 109a is divided into a plurality of n electrodes extending in the X direction, thereby the scan electrode driving circuit 204 can apply a voltage to the divided individual scan electrode 109a, as shown FIG. 8. The counter electrode 121 is formed on the counter substrate 120 in solid. Here, the counter electrode 121 is electrically connected to the ground wire 170, thereby holding 0V of a potential. The scan electrode 109a and the counter electrode 121 are made of a transparent material such as ITO.

The polarization axes of the transmission lights of the polarization axis conversion panel 1114b are dependent on the alignment orientation of the liquid crystal layer 150 sandwiched between the component substrate 110 and the counter substrate 120. The alignment orientation of the liquid crystal layer 150 is controlled by an electric field, which is created by a potential difference between a scan electrode 109a on the component substrate 110, and the counter electrode 121 of the counter substrate 120.

The liquid crystal layer 150 may include a TN liquid crystal. Accordingly, in the case that an electric field between the scan electrode 109a and the counter electrode 121 is off-state, the alignment orientation of the TN liquid crystal molecules is offset from the component substrate 110 side and the counter substrate 120 side by 90 degrees, and thereby, the polarization axis of the display lights transmitted to the polarization axis conversion panel 1114b is converted by 90 degrees (refer to FIG. 7A). On the other hand, in the case that an electric field between the scan electrode 109a and the counter electrode 121 is on-state, the alignment orientation of the TN liquid crystal molecules is changed by the electric field created by the substrates, and thereby the polarization axis of the display lights transmitted to the polarization axis conversion panel 1114b is not converted (refer to FIG. 7B).

The TN liquid crystal molecules making up the liquid crystal layer 150 preferably have a rapid response to a driving voltage. If the response is slow, it is difficult to precisely control the conversion timing of the polarization axis of the transmission light, thereby, the separation control of the image for the right eye and the image for the left eye is degraded resulting in a poor-quality image.

Next, referring FIG. 8, an electrical configuration of the polarization axis conversion panel 1114b is disclosed. FIG. 8 is a block diagram showing a simplified configuration of the polarization axis conversion panel 1114b. The polarization axis conversion panel 1114b may include a transmission area 110a and a scan electrode driving circuit 204.

The conversion operation by the polarization axis conversion panel 1114b is controlled by a controller 400. Here, the controller 400 is referred to as the common controller 400 used in the liquid crystal panel 1 in FIG. 6.

In the transmission area 110a of the polarization axis conversion panel 1114b, n (n is a natural number equal to or greater than 2) scan electrodes 13a are formed in the X direction successively. The potential difference of the scan electrode 109a can be controlled by controlling an applied voltage thereto, through an electrically connected scan electrode driving circuit 204. The control of this applied voltage is disclosed below in more detail.

The controller 400 obtains a clock signal (CLK) and a vertical scanning signal (VSYNC), and then generates a scanning-side start pulse (DY) and a scanning-side transmission clock (CLY). The obtaining of a scanning-side start pulse (DY) and a scanning-side transmission clock (CLY) allows the scan electrode driving circuit 204 to output in sequence a driving voltage (L1, L2, L3, . . . Ln) corresponding to n scan electrode 109a from the controller 400. The scan electrode driving circuit 204 outputs a driving voltage in sequence based on the scanning-side transmission clock (CLY) and the scanning-side start pulse (DY) supplied from the controller 400, which, for example, may be configured by a shift register. Although in the embodiment, a line sequence method is employed to output the driving voltage (Ln), other driving methods can be used.

### Control of Liquid Crystal Panel and Polarization Axis Conversion Panel

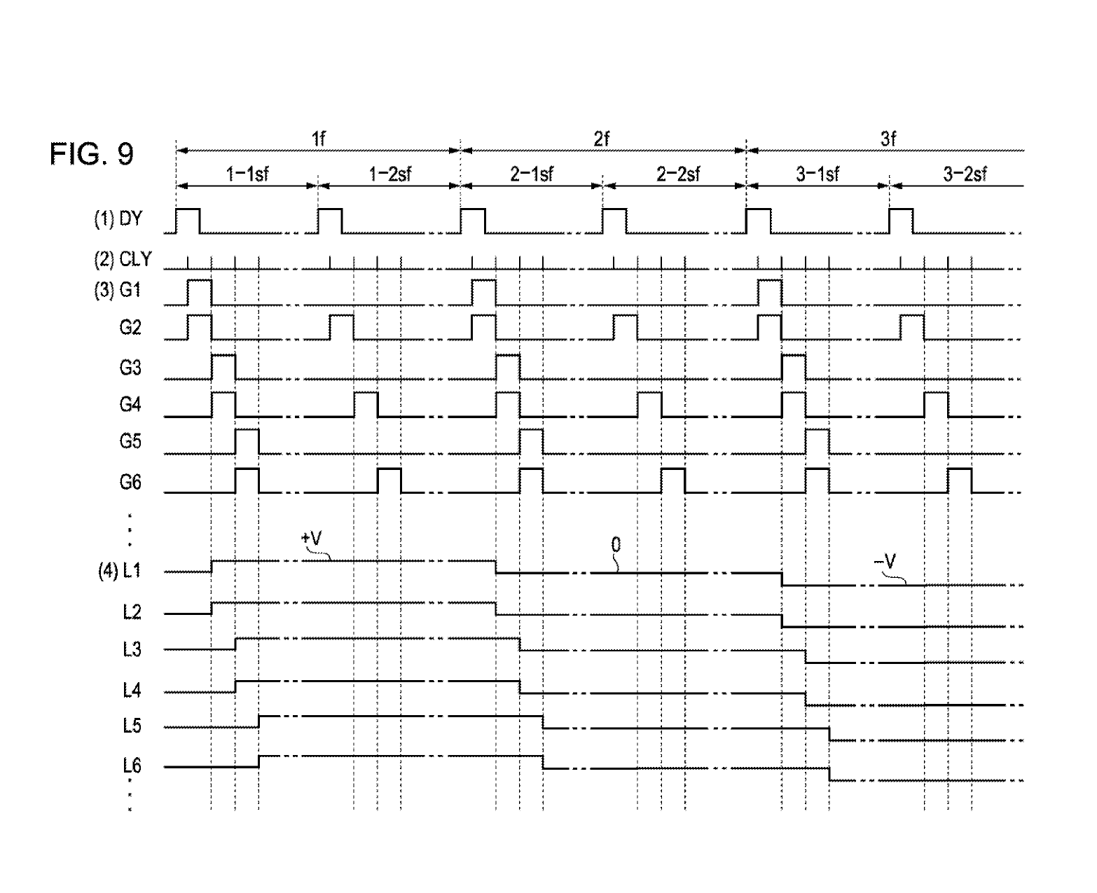

Now, referring to FIG. 9, through an explanation of each control signal which is inputted/outputted to/from the liquid crystal panel 1 and the polarization axis conversion panel 1114b, the operation of the liquid crystal projector 1100 of the embodiment is described. FIG. 9 is a timing chart of each control signal which is inputted/outputted to/from the liquid crystal panel 1 and the polarization axis conversion panel 1114b during the operation of the liquid crystal projector 1100 of the embodiment.

(1) of FIG. 9 illustrates a timing chart, showing a scanning-side start pulse (DY) supplied to a scanning-line driving circuits 104 of the liquid crystal panel 1 and a scan electrode driving circuit 204 of the polarization axis conversion panel 1114b. If a scanning-side start pulse (DY) is supplied to a scanning-line driving circuits 104, in the liquid crystal panel 1, the scanning-line driving circuits 104 starts supplying a scan signal (Gn) to n scan lines 3a(see (3) of FIG. 9). On the other hand, in the polarization axis conversion panel 1114b, if a scanning-side start pulse (DY) is supplied to the scan electrode driving circuit 204, the scan electrode driving circuit 204 starts supplying a driving voltage (Ln) to n scan electrodes 109a (see (4) of FIG. 9).

(2) of FIG. 9 illustrates a timing chart, showing the scanning-side transmission clock (CLY) supplied to the scan electrode driving circuit 204 of the polarization axis conversion panel 1114b and the scanning-line driving circuits 104 of the liquid crystal panel 1. In the embodiment, the scanning-side transmission clock (CLY) is operated in such a manner that on and off voltages are applied to it alternatively for a predetermined period. If a scanning-side start pulse (DY) is supplied, it is synchronized with the scanning-side transmission clock (CLY), and then the scanning-line driving circuits 104 supply the scan signal (Gn) to n scanning lines 3a in sequence, and simultaneously the scan electrode driving circuit 204 supplies a driving voltage (Ln) to n scan electrodes 209a in sequence.

(3) of FIG. 9 displays a timing chart showing a scan signal (Gn) being supplied to the scan lines 3a by the scanning-line driving circuits 104 of the liquid crystal panel 1.

In a first subfield period (1-1sf) within a first field period (1f), after a scanning-side start pulse (DY) is supplied from the controller 400, the scan signals G1 and G2, G3 and G4, G5 and G6, . . . Gn−1 and Gn are supplied simultaneously to a pair of scanning-lines 3a which are next to each other, in sequence in every half period of a scanning-side transmission clock (CLY). If the supplying of the respective scan signals (Gn) to n scanning-lines 3a is completed, the next scanning-side start pulse (DY) triggers proceeding to the second subfield period (1-2f) and initiates supplying a scan signal (Gn) to the scanning-lines 3a again. With this configuration in which a scan signal (Gn) is supplied to a pair of scanning-lines 3a simultaneously, the time to complete supplying a scan signal (Gn) to all the scanning-lines 3a takes half the time of supplying a scan signal (Gn) to each scanning-line 3a one at a time. That is, in the first field period, a scan signal (Gn) is supplied to a plurality of scanning-lines 3a simultaneously in the first subfield period (1-1sf), and a scan signal is supplied to only n/2 scanning-lines 3a in the second subfield period (1-2sf), thereby the length of the first field period is reduced in the time axis resulting in the increase in the field frequency.

Accordingly, since a pair of scanning-lines 3a in the first subfield period (1-1sf) within the first field period are driven at the same time, the same image data signal (Ds) is supplied to a pixel section 14 on the same data lines 6a, among the pixel sections on the driven pair of scanning-lines 3a. In other words, the image displayed in the image display area 10a in the first subfield period (1-1sf) has a resolution which is one half lower compared to supplying a scan signal (Gn) one at time. However, in the first subfield period (1-1sf), achieving an increase in the field frequency compensates for a low quality of resolution.

In the second subfield period (1-2sf), after a scanning-side start pulse (DY) is supplied from the controller 400, a scan signal (Gn) is supplied only to even numbered scanning-lines 3a in every half period of a scanning-side transmission clock (CLY). Specifically, in the second subfield period (1-2sf), a scan signal (G2, G4, G6, . . . , Gn) is supplied sequentially to n/2 scanning-lines 3a which are even numbered. After supplying of a scan signal (Gn) to respective n/2 scanning-lines 3a is completed, at the supplying timing of the next scanning-side start pulse (DY) it proceeds to the second field period (2f) to supply a scan signal (Gn) to the scanning-lines 3a again. That is, in the second subfield period (1-2sf) a scan signal (Gn) is supplied only to n/2 scanning-lines 3a, so that a length of the subfield period is reduced to one half compared to supplying a scan signal (Gn) to n scanning-lines 3a in sequence on the time axis. It allows increase of the field frequency by supplying a scan signal (Gn) only to a portion of the scanning-lines 3a in the second subfield period (1-2sf).

Here, as a scan signal (Gn) is not supplied to the pixel section 14 on the n/2 scanning-lines 3a which are odd numbered in the second subfield period (1-2sf), a new image data signal (Ds) is not applied during the second subfield period (1-2sf). Furthermore, the pixel section 14 of the liquid crystal panel 1 has a retention characteristic maintaining the image data voltage (Ds) applied previously as long as a new scan signal (Gn) is not supplied, so that the image data voltage (Ds) applied during the first subfield period (1-1sf) is maintained during the second subfield period (1-2sf). Accordingly, the pixel section 14 on the n/2 odd-numbered scanning-lines 3a to which a scan signal (Gn) in the second subfield period (1-2sf) is not supplied maintains the display image displayed in the first subfield period (1-1sf), thereby it makes up part of the display image in the second subfield period (1-2sf).

With this configuration, the display image in the second subfield period (1-2sf) substantially includes a newly displayed image in the second subfield period (1-2sf) added to the image displayed in the first subfield period (1-1sf), causing the display lights corresponding to both images to have the same polarization axis direction. The selection of the polarization axis of the display lights can be controlled by the polarization axis conversion panel 1114b, and it will be described later in detail in accordance with a control method thereof.

However, the pixel section 14 on the n/2 even numbered scanning-lines 3a in the second subfield period (1-2sf) in which a new scan signal (Gn) is supplied displays a different image from the first subfield period (1-1f). That is, in the first subfield period (1-1sf) a lower resolution image is displayed because a scan signal (Gn) is supplied simultaneously to a pair of the scanning-lines 3a which are next to each other, however, in the second subfield period (1-2sf) by overwriting the image corresponding to the pixel section 14 on the n/2 even numbered scanning-lines 3a, a higher resolution image is displayed compared to in the first subfield period (1-1sf).

As disclosed above, the quality of the display image is improved by displaying the higher resolution image in the second subfield period compensating for a lower resolution in the first subfield period due to a increase of the field frequency. Consequently, through the entire first field period (that is, the first and second subfield periods) it is possible to accomplish both an increase in the field frequency and a high resolution of the display image, thus allowing for displaying a high quality image.

During the second field period (2f), a scan signal (Gn) is supplied to scanning-lines 3a in the same pattern as the first field period.

(4) of FIG. 9 shows a timing chart showing the supplying of a driving voltage Ln to the scan electrode driving circuit 204 of the polarization axis conversion panel 1114b.

In the first subfield period (1-1sf) within the first field period (1f), after a scanning-side start pulse (DY) is supplied from the controller 400, a driving voltage (L1 and L2, L3 and L4, L5 and L6, . . . , Ln−1 and Ln) of on-state (that is, +V) is supplied simultaneously to a pair of scan electrodes 109a which are next to each other in every half period of a scanning-side transmission clock (CLY) in sequence so as to correspond to a sequence supplying a scan signal (Gn) in the liquid crystal panel 1 (see (3) of FIG. 9).

In the second subfield period (1-2sf) within the first field period (1f), the display image of the liquid crystal panel 1 substantially includes a practically newly displayed image in the second subfield period (1-2sf) added to the image displayed in the first subfield period (1-1sf), causing the display lights corresponding to both images to have the same polarization axis direction. Accordingly, as shown (5) of FIG. 9, a driving voltage (Ln) applied to a scan electrode 109a of the polarization axis conversion panel 1114b in the second subfield period (1-2sf) is maintained at a value applied in the first subfield period (1-1sf). Thus, the control of the driving voltage (Ln) allows the display lights in the first and second subfield periods to have the same polarization axis direction.

In the first subfield period (2-1f) and the second subfield period (2-2f) within the second field period (2f), the polarization axis conversion panel 1114b is controlled such that the polarization axis of the display light intersects the polarization axis of the display light in the first field period (1f).

In the first subfield period (2-1sf) within the second field period (2f), after a scanning-side start pulse (DY) is supplied from the controller 400, a driving voltage (L1 and L2, L3 and L4, L5 and L6, . . . , Ln−1 and Ln) of off-state (that is, zero) is supplied simultaneously to a pair of scan electrodes 109a which are next to each other in every half period of a scanning-side transmission clock (CLY) in sequence so as to correspond to a sequence supplying a scan signal (Gn) in the liquid crystal panel 1.

As the display image in the second subfield period (2-2sf) of the liquid crystal panel 1 needs to be displayed together with the image in the first subfield period (2-1sf), the display lights to project both images need to have the same polarization axis direction. Furthermore, as shown (5) FIG. 9, a driving voltage (Ln) supplied to a scan electrode 109a of the polarization axis conversion panel 1114b in the second subfield period (2-2sf) is maintained at a value applied in the first subfield period (2-1sf). Accordingly, the display lights of the first and second subfield periods have the same polarization axis direction as a result of controlling the driving voltage (Ln).

During the first and second subfield periods (3-1sf and 3-2sf) of the third field period (3f), basically a driving voltage (Ln) is supplied to a scan electrode 109a in the same pattern as in the first and second subfield periods (1-1sf and 1-2sf) of the first field period (1f). However, in the first and second subfield periods (3-1sf and 3-2sf), a driving voltage (Ln) which is on-state applied to a scan electrode 109a is −V not a +V. This is to prevent a decrease of the life time of the polarization axis conversion panel 1114b because if an on-state driving voltage (Ln) is applied with a positive polarity of +V constantly, it causes a burn-out in the liquid crystal layer 150 configured as a TN liquid crystal sealed in the polarization axis conversion panel 1114b.

For the fourth field period (not shown FIG. 9), a driving voltage (Ln) is supplied to a scan electrode 109a basically in the same pattern as in the second field period (2f).

From the fifth field period, a driving voltage (Ln) is supplied to a scan electrode 109a basically in the same pattern as in the first to the fourth field periods as described above.

In the odd numbered subfield periods of the respective field periods, driving voltage (L1, L2, L3, . . . , Ln) supply timing is delayed by one half of a scanning-side transmission clock (CLY) with respect to the scan signal (G1, G2, G3 . . . , Gn) supply timing in the liquid crystal panel 1. This delay is to prevent the image for the right eye and the image for left eye from mixing due to the different response speeds between the liquid crystal panel 1 and the liquid crystal sealed in the polarization axis conversion panel 1114b, and the like. Thus, a length of the time delay can be determined so as to form the display lights having the 90-degree different polarization axes for projecting the image for the right eye and the image for the left eye by an experimental or a theoretical way or a simulation, considering the features of the liquid crystal panel 1 and the polarization axis conversion panel 1114b.

By repeating the control described above, the polarization axis conversion panel 1114b is driven using the liquid crystal panel 1, so that it is possible to process properly the image for the right eye and the image for the left eye so as to have 90 degree offset polarization axes.

In the embodiment, the number of scanning-lines 3a of the liquid crystal panel 1 and the number of scan electrodes 109a of the polarization axis conversion panel 1114b are the same, but they can be different. When they are different, there is a need to control the scanning-line driving circuits 104 and the scan electrode driving circuit 204 so as to synchronize the field frequency of the polarization axis conversion panel 1114b with the liquid crystal panel 1. For example, it is preferable to control the scanning-line driving circuits 104 and the scan electrode driving circuit 204 so as to synchronize the frame period of the polarization axis conversion panel 1114b with the liquid crystal panel 1.

### Modified Embodiment

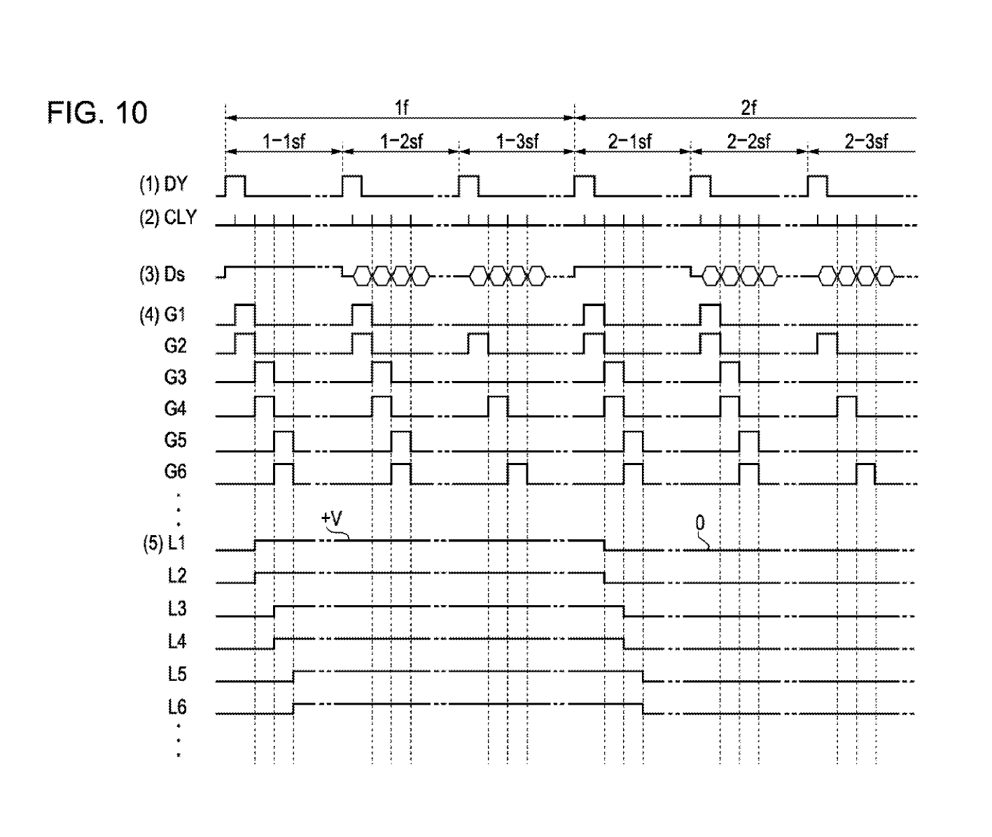

Referring to FIG. 10, a modified embodiment of the above described embodiment is disclosed. FIG. 10 is a timing chart of the respective control signal inputted/outputted to/from the liquid crystal panel 1 and the polarization axis conversion panel 1114b during the operation of the liquid crystal projector 1100 related to the modified example. Specially, (1) of FIG. 10 illustrates a timing chart showing the supplying of a scanning-side start pulse (DY) to the scanning-line driving circuits 104 of the liquid crystal panel 1 and the scan electrode driving circuit 204 of the polarization axis conversion panel 1114b. (2) of FIG. 10 shows a timing chart showing the supplying of a scanning-side transmission clock (CLY) to the scanning-line driving circuits 104 of the liquid crystal panel 1 and the scan electrode driving circuit 204 of the polarization axis conversion panel 1114b. (3) of FIG. 10 is a timing chart showing the supplying of an image data signal (Ds) to the pixel section 14 by the data line driving circuit 101 of the liquid crystal panel 1. (4) of FIG. 10 shows a timing chart showing the supplying of a scan signal (Gn) to scanning-lines 3a by the scanning-line driving circuits 104 of the liquid crystal panel 1. (5) of FIG. 10 shows a timing supplying driving voltage (Ln) to the scan electrode driving circuit 204 of the polarization axis conversion panel 1114b. The liquid crystal projector 1100 according to the modified embodiment is distinguished from the above described embodiment by a black color display being provided in the image display area 10a of the liquid crystal panel 1 in a field period in which the conversion operation of the polarization axis conversion panel 1114b is performed.

As shown (3) of FIG. 10, as a result of changing the driving voltage (Ln) with the polarization axis conversion panel 1114b, in the first subfield period (1-1sf) of the first field period (1f) and the first subfield period (2-1sf) of the second field period (2f) performing the conversion operation of the polarization axis for the display lights, it is necessary to set the image data voltage (Ds) supplied from the data-line driving circuit 101 of the liquid crystal panel 1 to the respective data-lines 6a to a high level to display a black color in the image display area 10a of the liquid crystal panel 1. On the other hand, in other subfield periods (1-2sf, 1-3sf, 2-2sf and 2-3sf) in which the conversion operation of the polarization axis for the display light is not performed, an image data voltage (Ds) corresponding to the projected image is applied to the data-line driving circuit 101 of the liquid crystal panel 1. Here, the first subfield period (1-1sf) of the first field period (10 and the first subfield period (2-1sf) of the second field period (2f), displaying a black color display, are examples of the third subfield period.

Thus, in the subfield periods in which the conversion of the polarization axis for the display light is performed by the polarization axis conversion panel 1114b, a black color is displayed in the image display area 10a of the liquid crystal panel 1, thereby it is possible to effectively prevent the image for the right eye and the image for the left eye from mixing together. That is, to convert the polarization axis of the display light, in the transmission area 110a of the polarization axis conversion panel 1114b there are areas to which a driving voltage (Ln) is already applied and an area to which a driving voltage is not applied yet. In this arrangement, the alignment orientations of the liquid crystal layer 150 are different between areas, so that the alignment axis of the display light cannot be specified to one. Here, according to the modified embodiment, it is possible to prevent effectively the image for the right eye and the image for the left eye from mixing together by projecting the display image after assuring the completion of the conversion operation of the polarization axis for the display light by the polarization axis conversion panel 1114b.

It is to be understood that the invention is not limited to the above-described embodiments and that various changes and modifications may be made without departing from the sprit and scope as set out in the accompanying claims and the specification; driving circuits of the electro-optical device that undergo such changes and modifications, electro-optical devices including such driving circuits, and electronic apparatuses having such electro-optical devices are also within the technical scope of the invention.

What is claimed is:

1. An electro-optical device which displays a three-dimensional image to a viewer, the three-dimensional image including a right-eye image and a left-eye image, the device comprising:
a plurality of scanning lines;
a plurality of data lines;
a plurality of pixel circuits that are disposed at positions corresponding to intersections between the plurality of scanning lines and the plurality of data lines;
a scanning signal supply unit which supplies a scanning signal to the plurality of pixel circuits via the scanning lines; and
an image signal supply unit which supplies an image signal to the plurality of pixel circuits via the data lines, the image signal corresponding to either the right-eye image or the left-eye image at right-eye image field intervals and left-eye image field intervals,
the electro-optical device being configured such that:
the left-eye image is supplied during a first field period and the right-eye image is supplied during a second field period immediately following the first field period, the first field period and the second field period each having a first sub-field period and a second sub-field period,
wherein during the first sub-field period, the scanning signal is supplied simultaneously to each of the plurality of scanning lines, and during the second sub-field period, the scanning signal is supplied to only a subset of the plurality of scanning lines without supplying the scanning signal to all of the scanning lines.

2. The electro-optical device according to claim 1, wherein prior to the first-subfield period, the image signal supply unit supplies an image signal corresponding to a black display.

3. An electronic apparatus comprising the electro-optical device according to claim 1.
